(19) United States
(12) Patent Application Publication
(10) Pub. No.: US 2005/0234964 A1
(43) Pub. Date: Oct. 20, 2005

(54) System and method for creating dynamic workflows using web service signature matching

(76) Inventors: Virinder Mohan Batra, Chapel Hill, NC (US); Mine Altunay, Raleigh, NC (US); Chetna Dnyandeo Warade, Arlington, MA (US); Daniel Colonnese, Durham, NC (US); Satyaprasad Vadlamudi, Chapel Hill, NC (US)

Correspondence Address: HOFFMAN WARNICK & D'ALESSANDRO, LLC, 75 STATE STREET, 14TH FL, ALBANY, NY, 12207, US

(21) Appl. No.: 10/827,566

(22) Filed: Apr. 19, 2004

(51) Int. Cl. G06F 17/30

(52) U.S. Cl. 707/102

(57) ABSTRACT

A system and method for dynamically implementing a chain of Web services from a client on the World Wide Web to execute a workflow. The described system includes: a database for storing a list of available Web services, wherein each listed Web service includes a description of a task performed by the Web service, and an input and output signature of the Web service; and a selecting system for forming the chain of Web services by selecting a Web service for each of a plurality of tasks in the workflow, wherein the selecting system matches input and output signatures to ensure that each selected Web service is compatible with adjacent Web services in the chain of Web services.

### BACKGROUND OF THE INVENTION

1. Technical Field

The present invention relates generally to computational workflows, and more specifically relates to a system and method for automating the creation of workflows in a Web services environment.

2. Related Art

The transition of the World Wide Web from a paradigm of static Web pages to one of dynamic Web services provides new and exciting opportunities for scientists with respect to data dissemination, transformation, and integration. Today, scientists can easily post their research findings on the Web or compare their discoveries with previous work, often spurring innovation and further discovery. The value of accessing data from other institutions and the relative ease of disseminating this data has caused an increase in capacity for collaboration. Increased collaboration produces dramatically larger data sets than were previously available, which require advanced data management techniques for full utilization. However, the rapid growth of Web services, coupled with non-standardized interfaces, diminish the potential that these Web services offer.

One particular area that can particularly benefit from Web services involves bioinformatics and, more specifically, microarray technology. Microarray technology is a very powerful tool for medical and biological research that allows the monitoring of expression levels of thousands of genes simultaneously. Microarray experiments generate overwhelmingly large amounts of data. In order to make sense out of this data one needs to use a series of sophisticated software tools. Creating effective workflows of such tools is critical for analyzing microarray data.

Workflows enable automation of a probe design and annotation for a set of probes used in a microarray gene expression experiment. Unfortunately, current computational models allow bioinformaticians to perform only basic analysis operations on the genome data generated from the microarray experiments. Accordingly, a series of application tools must be utilized for analysis. However, due to incompatibilities, inputs and ouputs from the various tools must be coordinated, for instance, using a high number of screen scraping operations. This is not only tedious but highly error prone. Screen scraping is a technique used to interface one system with another, by means of emulating user (i.e., screen) interaction. Screen scraping “maps” the location of the various screens and the input fields for the information. Screen scraping will then emulate the input of an electronic user using the system at a terminal. This technique is not the preferred means of interfacing systems, as it is slow and rather crude. However, it remains a viable means where other interfaces options are not viable.

In a typical workflow scenario, various Web services may be utilized to provide specialized tasks. Web services, or application services, may be generally defined as computer programs that are accessible over the Web. For example, a set of gene sequences in a FASTA or XML file format may be inputted into a BLAST Homology Web service, which in turn generates a set of gene sequences as output that will serve as input for other sequence analysis applications. The output file format could again be a FASTA or XML format. A filtering Web service could be used to perform a filtering operation on the output in order to generate a filtered set of gene sequences with ideal GC content and melting temperatures (again in FASTA or XML format). Further, the set of gene sequences from the filtering Web service could be submitted to an annotation tool to identify and track the characteristics of the sequences. The output of the annotation tool would comprise the filtered set of gene sequences with marked annotation. The input and output file formats could again be FASTA or XML. Lastly, a spatial design Web service may be implemented to take as input the list of sequences, which will be the probes in the microarray. The spatial design Web service will create database entries in the probe database reflecting each entry, its attributes, and its spatial placement on the microarray. Again, this operation could use various file formats like FASTA or XML or flat text file. Each tool has its own unique input and output format. Accordingly, stringing together a series of workflow operations requires conversion operations that may require additional Web Service tools.

Because there is no common interface or data exchange mechanism for these sites, a challenge exists with regard to creating dynamic workflows at runtime. In particular, difficulties exist with respect to determining which Web service to use (or bind) at runtime. Accordingly, a need exists to facilitate this process.

### SUMMARY OF THE INVENTION

The present invention addresses the above-mentioned problems, as well as others, by providing a system and method that uses a local database of input/output signature data to dynamically implement a chain of compatible Web services. In a first aspect, the invention provides a system for dynamically implementing a chain of Web services from a client on the World Wide Web to execute a workflow, comprising: a database for storing a list of available Web services, wherein each listed Web service includes a task performed by the Web service, and an input and output signature of the Web service; and a selecting system for forming the chain of Web services by selecting a Web service for each of a plurality of tasks in the workflow, wherein the selecting system matches input and output signatures to ensure that each selected Web service is compatible with adjacent Web services in the chain of Web services.

In a second aspect, the invention provides a program product, stored on a recordable medium for executing a workflow by dynamically implementing Web services from a client on the World Wide Web, comprising: means for storing a list of available Web services, wherein each listed Web service includes a task performed by the Web service, and an input and output signature of the Web service; and means for forming a chain of Web services by selecting a Web service for each of a plurality of tasks in the workflow, wherein the forming means matches input and output signatures to ensure that each selected Web service is compatible with adjacent Web services in the chain of Web services.

In a third aspect, the invention provides a method for executing a bioinformatics workflow from a client on the World Wide Web, comprising: providing a workflow having a plurality of tasks; providing a list of known bioinformatics Web services, wherein each listed Web service includes a task performed by the Web service, and an input and output signature of the Web service; selecting a Web service from the list of known bioinformatics Web services for each task in the bioinformatics workflow to form a chain of Web services, wherein the selecting step matches input and output signatures to ensure that each selected Web service is compatible with adjacent Web services in the chain of Web services; and calling each selected Web service in the chain to execute the bioinformatics workflow.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a microarray workflow system in accordance with the present invention.

FIG. 2 depicts a Web services chain in accordance with the present invention.

### DETAILED DESCRIPTION OF THE INVENTION

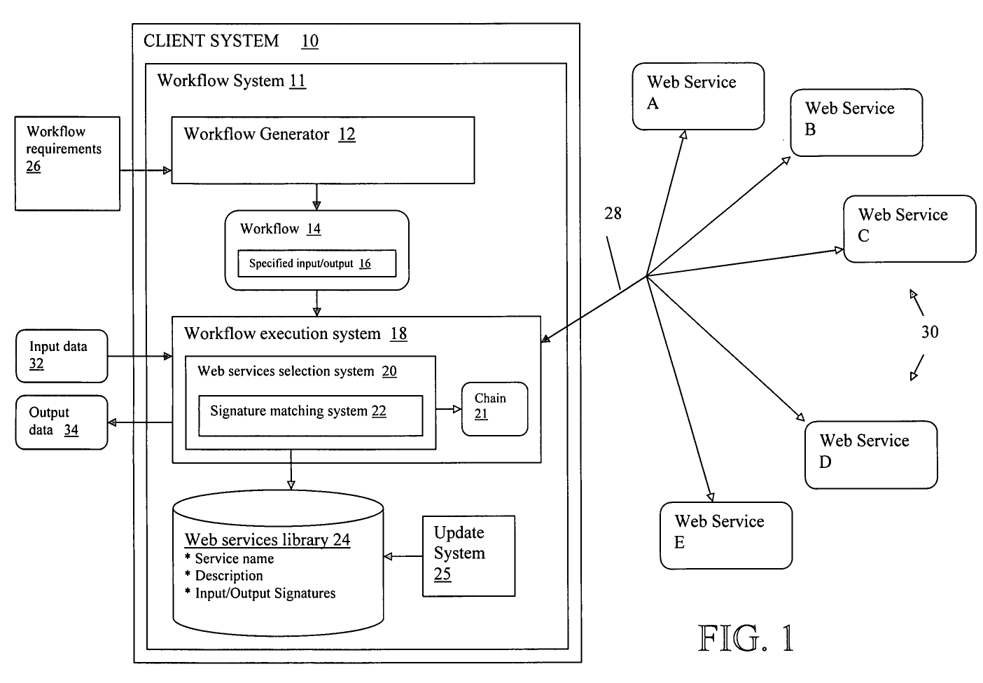

Referring now to the drawings, FIG. 1 depicts a workflow system 11 that operates from a client system 10 on the World Wide Web 28. Client system 10 may comprise any type of system, including software and/or hardware, capable of providing communications over the Web 28. In a typical embodiment, client system 10 may comprise a browser, and workflow system 11 comprises a software program that is executable from within client system 10 to effectuate communications over the Web 28 with Web services 30.

Workflow system 11 includes a workflow generator 12 that generates a workflow 14 based on a set of workflow requirements 26. Workflow 14 generally consists of a sequence of linked “tasks” which are required to meet the workflow requirements 26. Each task can be accomplished using any available Web service appropriate for the task (e.g., Web Service A or C). The entire set of tasks specified by the workflow 14 generally requires implementing a chain of Web services (e.g., Web services B->A->E->D). Systems for creating workflows, such as that sold under the trade name INFORSENSE™ are known in the art, and therefore are not discussed in detail herein.

In a typical application, workflow 14 may have a specified input and output signature 16, e.g., in a bioinformatics application the specified input signature to workflow 14 may comprise a FASTA XML format for a set of input sequences, and the output signature may comprise an XML file format for providing spatial microarray placement data. Obviously, the types of input and output signatures, as well as the functions performed by the workflow 14 can vary without departing from the scope of the invention. In addition, although this description includes an exemplary embodiment directed to a system for using Web services for analyzing microarray data, the invention could be applied to any bioinformatics application utilizing Web services, and more generally could apply to any application where a series of Web services are required.

Once a workflow 14 is created, it can be implemented by workflow execution system 18, which reads in a set of input data 32 (e.g., sequences), processes the data by executing a chain 21 of Web services, and generates a set of output data 34 (e.g., sequences, microarray placement, etc.). As noted above, the chain 21 of Web services must be executed over the Web 28 to perform tasks specified by the workflow 14. Web services selection system 20 dynamically identifies and selects the chain 21 of Web service to complete each task required by workflow 14.

A significant challenge in selecting Web services is the fact that the input and output signature of different Web services 30 are not always compatible, i.e., the output data format of a first Web service may be different than the input data format of a second Web service. Accordingly, if the input and output signatures of adjacent Web services in the chain 21 of Web services are not compatible, execution of the workflow cannot be automated (i.e., manual intervention will be required to convert formatting). Web services selection system 20 addresses this problem as follows.

First, it is recognized that there may be multiple Web services available to perform one or more of the tasks specified by the workflow 14. Workflow system 11 includes a locally maintained Web services library 24, which stores information about each known/available Web service. Web services library 24 includes the names, descriptions (i.e., tasks the service can perform), and input and output signatures of the known Web services 30. For each specified task, Web services selection system 20 examines the library 24 and determines, at run time, which set of Web services should be used. While the present embodiment utilizes a library 24 to hold available Web services data, it should be recognized that any database (e.g., data object, RAM, ROM, etc.) could be used for maintaining a list of available Web services.

To facilitate the process of selecting Web services during workflow execution, a signature matching system 22 is utilized to dynamically match input and output signatures of available Web services. Thus, during execution, signature matching system 22 can examine all known Web services capable of completing each task in the workflow 14, and determine which Web services having matching input/output signatures. In particular, input and output signatures are matched to ensure that each selected Web service is compatible with adjacent Web services in the chain 21 of Web services. The resulting chain 21 of compatible Web services can then be implemented in an automated fashion to complete the required tasks.

Consider the following example in which workflow 14 specifies three sequential tasks, Task1, Task2, and Task3, in which the first task Task1 must receive an input in a format “In1,” and the last task Task3 must generate an output in a format “Out3.” Accordingly, workflow 14 would look as follows:
In1->Task1->Task2->Task3->Out3
   Initially, Web services selection system 20 would examine Web services library 24 to determine known sets of Web services capable of performing the required tasks. Assume Web services selection system 20 identified from Web services library 24 the following Web services (Sn) capable of performing each task:
Task1: S1, S2, S3, S4, S5
Task2: S6, S7, S8, S9
Task3: S10, S11, S12, S13
   In this example, Web services library 24 lists five Web services (S1, S2, S3, S4, S5) capable of performing Task1. Signature matching system 22 would determine which of those services have an input signature that matches format In1. Assume a subset of the Task1 Web services S1, S3 and S4 utilize input format In1. At this point, Web services selection system 20 would begin building a chain as follows:
In1->[S1, S3, S4]
   The output signatures of subset [S1, S3, S4] would be noted from information stored in Web services library 24, and matched with the input signatures of Task2 Web services. Assume for instance that the output signature of S1 matched the input signature of S6, the output signature of S3 matched the input signatures of S8 and S9, and the output signature of S4 did not match any input signatures from the Task2 Web services. Because two potential matches were identified, Web services selection system 20 would build the following two chains:
Iin1->S->S6
Iin1->S3->[S8, S9]
   In a similar fashion, the output signatures of S6, S8 and S9 would be examined, and matched with the input signatures of the Task3 Web services. In this case, assume that the output signature of S6 matched with the input signature of S13, the output signature of S8 matched with the input signature of S10, and the output signature of S9 did not match with the input signature of any Task3 Web services. At this point, the possible chains would comprise:
In1->S1->S6->S13
In1->S3->S8->S10
   Here, the output signatures of S13 and S10 would be examined, and matched with the required workflow output signature format Out3. Assume that only S10 outputted a signature format Out3. Accordingly, a resulting chain that could be used during execution to perform all of the necessary tasks of the specified workflow 14 in an automated fashion would be:
In1->S3->S8->S10->Out3

Obviously, the above example describes just one possible embodiment for implementing a dynamic Web services selection process, and other features and/or methods could be utilized. For instance, Web services selection system 20 could begin with the required output signature and work its way backward to the input to form a chain 21. Web services selection system 20 could also include algorithms for handling cases where a chain must be selected from multiple possible chains, as well as cases where no single chain can be formed. Moreover, Web services selection system 20 could include an algorithm for implementing a Web service or program to convert an output format to a required input format in the case, e.g., when no compatible Web services existed to form a link between two required tasks.

Workflow system 11 may also include an update system 25 for managing and updating the data in Web services library 24 regarding existing Web services 30. Such data may be collected and stored in any known manner, e.g., based on previous execution processes, using a netbot or similar program to scan the Web for such services, downloading from a central repository, manually, etc.

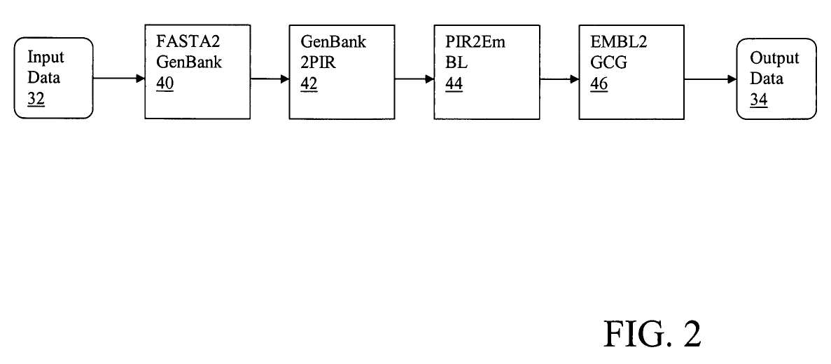

Referring now to FIG. 2, a simplified example of a bioinformatics Web services chain is shown, which receives input data 32 and generates output data 34. There are several types of file formats available today in bioinformatics for electronically representing and storing sequence (RNA, DNA) data type. Examples include FASTA (demo.fasta), GenBank (Genetic Sequence Data Bank—demo.genbank), EMBL (European Molecular Biology Laboratory—demo.embl), PIR (Protein Identifier Resource—demo.pir), and GCG (Genetics Computer Group—demo.gcg). In an exemplary embodiment, it can be seen that the generated chain includes compatible input and output signatures, i.e., the output signature (*.genbank file) of Web service 40 matches the input signature of Web services 42, etc.

(1) FASTA2GenBank 40,

Input: *.fasta file
Output: *.genbank file
   (2) GenBank2PIR 42,
Input: *.genbank file
Output: *.pir file
   (3) PIR2EMBL 44,
Input: *.pir file
Output: *.embl file
   (4) EMBL2GCG 46,
Input: *.embl file
Output: *.gcg file

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for dynamically implementing a chain of Web services from a client on the World Wide Web to execute a workflow, comprising:
a database for storing a list of available Web services, wherein each listed Web service includes a description of a task performed by the Web service, and an input and output signature of the Web service; and
a selecting system for forming the chain of Web services by selecting a Web service for each of a plurality of tasks in the workflow, wherein the selecting system matches input and output signatures to ensure that each selected Web service is compatible with adjacent Web services in the chain of Web services.

2. The system of claim 1, wherein the workflow comprises a microarray analysis workflow.

3. The system of claim 1, further comprising a workflow generator for creating the workflow.

4. The system of claim 1, wherein the list of available Web services resides locally with the client.

5. The system of claim 1, further comprising a system for collecting and storing available Web services data.

6. The system of claim 1, further comprising a system for inputting sequence data into the workflow execution.

7. The system of claim 1, wherein the workflow includes a specified input and output format.

8. A program product, stored on a recordable medium for executing a workflow by dynamically implementing Web services from a client on the World Wide Web, comprising:
means for storing a list of available Web services, wherein each listed Web service includes a description of a task performed by the Web service, and an input and output signature of the Web service; and
means for forming a chain of Web services by selecting a Web service for each of a plurality of tasks in the workflow, wherein the forming means matches input and output signatures to ensure that each selected Web service is compatible with adjacent Web services in the chain of Web services.

9. The program product of claim 8, wherein the workflow comprises a microarray analysis workflow.

10. The program product of claim 8, wherein the workflow comprises a bioinformatics workflow.

11. The program product of claim 8, further comprising means for creating the workflow.

12. The program product of claim 8, wherein the storage means resides locally with the client.

13. The program product of claim 12, further comprising means for collecting and storing available Web services data in said storage means.

14. The program product of claim 8, further comprising a system for inputting sequence data into the workflow execution.

15. The program product of claim 8, wherein the workflow includes a specified input and output format.

16. A method for executing a bioinformatics workflow from a client on the World Wide Web, comprising:
providing a workflow having a plurality of tasks;
providing a list of known bioinformatics Web services, wherein each listed Web service includes a description of a task performed by the Web service, and an input and output signature of the Web service;
selecting a Web service from the list of known bioinformatics Web services for each task in the bioinformatics workflow to form a chain of Web services, wherein the selecting step matches input and output signatures to ensure that each selected Web service is compatible with adjacent Web services in the chain of Web services; and
calling each selected Web service in the chain to execute the bioinformatics workflow.

17. The method of claim 16, wherein the bioinformatics workflow comprises a microarray analysis.

18. The method of claim 16, wherein the list of known bioinformatics Web services resides locally to the client.

19. The method of claim 16, wherein the workflow includes a specified input and output format.

20. The method of claim 19, wherein the step of calling each selected Web service includes the step of providing a set bioinformatics data to a first Web service in the chain in the specified input format.
